(19) United States
(12) Patent Application Publication
(10) Pub. No.: US 2009/0301444 A1
(43) Pub. Date: Dec. 10, 2009

(54) FUEL STABILIZER FOR INTERNAL COMBUSTION PETROL ENGINE

(76) Inventor: Mohammed Moosa I Kandnery, Bangalore (IN)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/914,267

(22) PCT Filed: Jul. 13, 2005
(86) PCT No.: PCT/IN05/00238

§ 371 Date: Nov. 13, 2007

(30) Foreign Application Priority Data
May 13, 2005 (IN) 568/CHE/2005

(51) Int. Cl. F02M 33/02

(52) U.S. Cl. 123/518

(57) ABSTRACT

The present invention discloses a device called as Fuel Stabilizer (10), which when installed with the existing Internal Combustion Engine System, but away from the engine prepares a judicious fuel air mixture for efficacious supply of the fuel-air ratio. Use of this fuel stabilizer (10) also minimizes or eliminates the production of poisonous gases in the exhaust which have direct environmental implication. This fuel stabilizer (10) saves up to 75% of fuel consumption in contrast of the existing Internal combustion Engines.

The present invention relates to a fuel stabilizer for internal combustion Petrol Engines. The aim of the present invention is to increase the fuel efficiency of internal combustion Engines by introducing the fuel stabilizer of the present invention as additional component into the existing system of Engines. The fuel stabilizer of the present invention also helps in reduction of pollutants of the exhaust gases.

It is a very well known fact that fuel-air mixture plays an important role for the Engine efficiency. Efficiency of an Engine is not only judicious use of fuel but also aiming at full burning of the fuel thereby reducing the pollutants. Various attempts have been made to convert fuel rich air mixture to air rich fuel mixture. So far these attempts have not been successful and the results are far from satisfactory. One of the disadvantages in the prior art is lack in control of fuel flow with respect to the Engine speed or performance. This invention does not vaporize the petrol in the inlet, of the internal combustion engine, as done by the carburetor and multi point fuel injection system. This invention condenses and processes air-fuel ratio to a required combination efficaciously in a unit or a gadget totally away from the engine as shown in FIG. 5.

With the constant and steep increase in the fuel costs an urgent need was felt to search for other alternatives by which fuel efficiency can be achieved. As the time is passing by, mostly in the developing countries, for so many reasons description of which is not necessary for the working of the present invention, the number of vehicles hitting the road are alarmingly increasing. It is obvious to any person to understand that more number of vehicles in operation means more fuel consumption, which further means more release of pollutants in the atmosphere. The noxious gases like nitrogen and sulfur oxides which are the ingredients of the exhaust gases from the not properly burnt fuels and responsible for major air pollution. The inventor of this invention also aims to minimize at the reduction of pollution level in the atmosphere. Along with carbon-dioxide these noxious gases are also responsible for earth warming, as the carbon-dioxide is the final product of complete and efficient burning of a fuel, nothing can be done in controlling the production of this gas. But by the reduction of noxious gases in the exhaust certainly reduces the earth warming and improves ENVIRONMENTAL implications. Therefore the aim of the present invention is to have a multipurpose unit through which the disadvantages of the prior art as mentioned above are minimized or eliminated.

The object of the invention is to provide a fuel stabilizer for internal combustion Petrol Engines.

The next object of the invention is for the judicious use of fuel.

The next object of the invention is to provide a judicious fuel-air mixture for efficient burning.

The next object of the invention is to control the feed of fuel-air mixture to the Engine depending upon the speed/capacity of the Engine.

The next object of the invention is to install the fuel stabilizer at appropriate location of the existing internal combustion Petrol Engine system.

The next object of the invention is to be ENVIRONMENTAL friendly that is minimize or eliminate the production of noxious gases from the Engine.

The next object of the invention is to increase the overall performance of a vehicle.

The next object of the invention is to provide vehicles with high performance and possibly with zero pollution.

According to the present invention there is provided a fuel stabilizer which has a fuel inlet and multiple inlets of air, a means for preparing the judicious mix of fuel-air mixture, a control unit for the regulation of amount of fuel to be sent to Engine through an outlet means.

### BRIEF DESCRIPTION OF THE ACCOMPANYING DRAWINGS

FIG. 1 is the perspective view of the fuel stabilizer of the present invention.

FIG. 2 is the bottom view of the fuel stabilizer.

FIG. 3 is the longitudinal section of the fuel stabilizer.

FIG. 4 indicates the isolated Engine system wherein the fuel stabilizer according to the invention is fitted therein.

FIG. 5 is the internal view of a four-wheeler shown as an example wherein the fuel stabilizer is fitted in, to emphasize that the addition of fuel stabilizer does not hamper the working system in any way.

In the following paragraphs the parts as depicted in the figures have been explained for better understanding of the present invention.

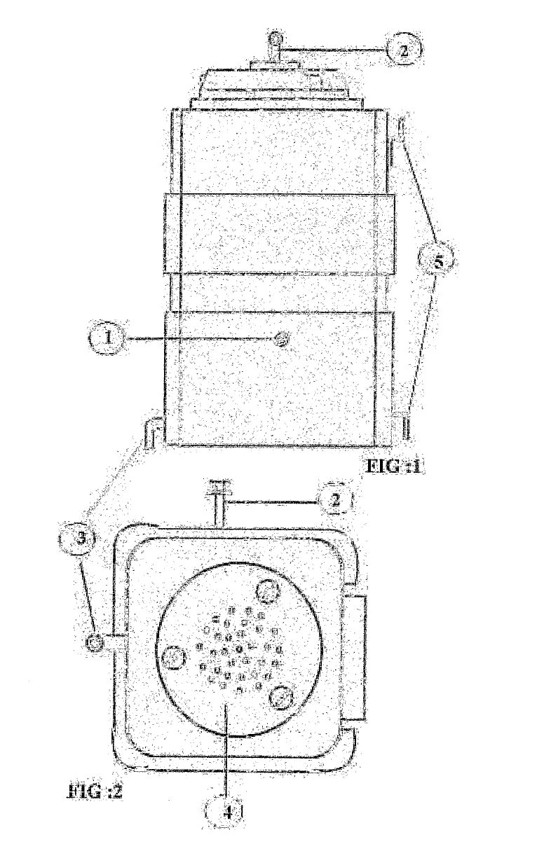

Sheet I shows FIG. 1 and FIG. 2. No. (1) Shows petrol inlet nozzle, which takes in petrol No. (2) Is the outlet nozzle, of the invention that supplies ready mixed energized air No. (3) Is the drain cock, to facilitate draining of adulterated fuel No. (4) Is the bottom of the invention that shows the air filter, to feed filtered air to the condenser for its requirement. No. (5) Bracket for fixing.

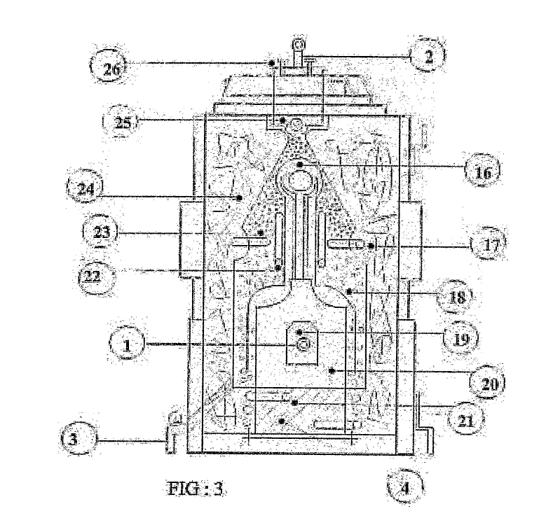

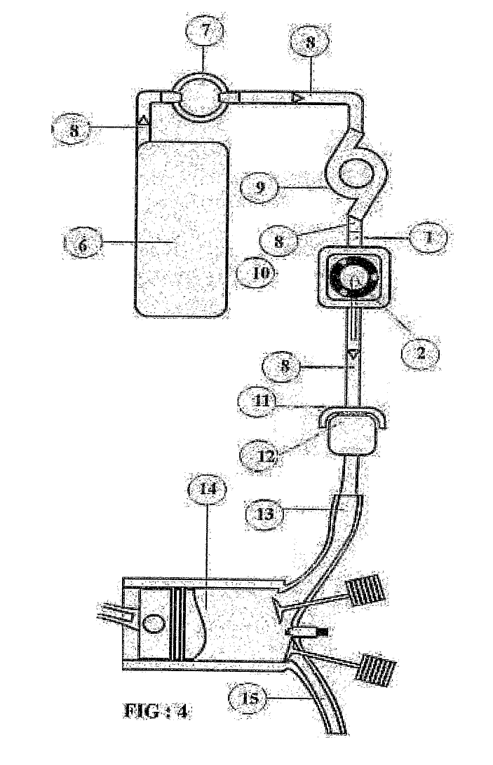

Sheet II FIG. 3. Shows how the stabilizer processes the fuel-air and enriches the air to feed the Engine inlet. No. (2) Fuel enriched air outlet nozzle. No. (16) Semi ozonized air intake value. No. (17) Air cycloning perforated tube. No. (18) Fuel rich air chamber. No. (19) Mechanical fuel control unit. No. (20) Semi vacuumized chamber. No. (21) Copper tube taking atmospheric filtered air. No. (4) Air filter. No. (3) Drain out value. No. (1) Fuel inlet nozzle. No. (22) Copper perforated tubes stabilizing enriched air efficaciously to suit Engine inlet. No. (23) Tubular heating fin. No. (24) Just cleaned atmospheric air chamber. No. (25) Ready enriched air auto-sealing during Engine idling. No. (26) Enriched air feed adjusters.

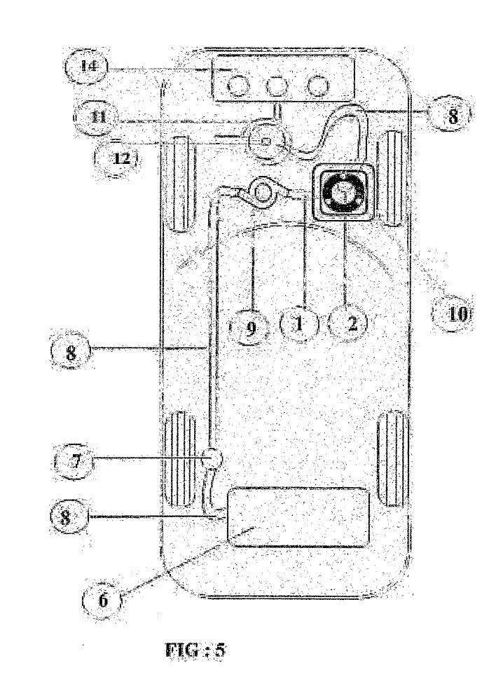

Sheet III shows FIG. 4. No. (6) The Fuel Tank. No. (7) The Fuel Filter. No. (8) Tubes. No. (9) The Fuel Pump. No. (1) Fuel Inlet of the Fuel Stabilizer for I/C petrol Engines. No. (10) Fuel Stabilizer for I/C Petrol Engines (The Invention). No. (2) Outlet of the Fuel Stabilizer for I/C petrol Engines. No. (11) Air Filter (which is attached to the air inlet of the carburetor or MPFI system). No. (12) Carburetor or the MPFI system of Air Inlet. No. (13) (Manifold) Fuel-Air Mix intake casing attached to Engine. No. (14) Combustion chamber of a cylinder. No. (15) The Exhaust port.

Sheet IV FIG. 5. Shows how the stabilizer system is to be installed in a car No. (6) The Fuel Tank. No. (7) The Fuel Filter. No. (9) The Fuel Pump. No. (1) Fuel Inlet nozzle of the Fuel Stabilizer for I/C petrol Engines. No. (10) Fuel Stabilizer for I/C petrol Engines. (The Invention). No. (2) Outlet nozzle of the Fuel Stabilizer for I/C petrol Engines. No. (8) Tubes. No. (11) Air Filter (which is attached to the air inlet of the carburetor or MPFI system). No. (12) Carburetor or the MPFI system of Air Inlet. No. (14) Internal Combustion Engine Cylinder.

### DETAILED DESCRIPTION OF THE INVENTION

Accordingly the present invention is related to a fuel stabilizer, which comprises a fuel inlet, multiple air inlets, a means for the preparation of judicious fuel-air mix, a means for controlling the flow of the prepared mix and an outlet for the mix.

This Invention is the first method, which condenses petrol-air efficaciously to stabilize the exact mixture of petrol-air (energized air) required for the explosion in the combustion chamber of Internal Combustion Petrol Engines. Which results by first of all saving 75% of Petrol Consumption and runs the Engine consuming only 25% of the petrol Compared to the conventional carburetor and fuel injected internal combustion Engines used for automobile and other purposes. And secondly it eradicates excess supply of petrol to the combustion chamber, when excess fuel is unburnt during explosion it creates poisonous gases at the exhaust. The FUEL STABILIZER FOR INTERNAL COMBUSTION PETROL ENGINES supplies efficacious ready mixture of air-petrol ratio to the fuel intake of internal combustion petrol Engines.

This invention is not only conservation of petrol to a significant extent, and to eradicate atmospheric pollution caused by all fuel Engines, even though the global automotive Engine industry has over the years, if for no other reasons than seeking competitive advantages through exerted efforts to increase the fuel economy of internal combustion petrol Engine the gains realized thereby have been deemed by governmental bodies as being insufficient and such governmental bodies continue to impose increasingly stringent regulation related to Engine for the maximum permissible emission of poisonous gas. The inventor has given great attention to totally eradicate the causes of excess fuel burnt by inventing the FUEL STABILIZER FOR INTERNAL COMBUSTION PETROL ENGINES and to boost national economy in grass root level by saving 75% petrol and minimizing tail pipe emissions that have ENVIRONMENTAL implications SINGLE-HANDEDLY. This result cannot be achieved by the multi point fuel injection system, which injects petrol-air with the assistance of electronic, electrical gadgets and with the necessary processor and software, which put together sophisticates the Engine, to an extent that the motorist has to spend abnormal charges on only workshops, that have been equipped with expensive fault sensing, indicating and recommending the necessary personal to attend.

This FUEL STABILIZER FOR INTERNAL COMBUSTION PETROL ENGINES is for processing petrol-air mixture that is a must and recognized combination in a unit WITHOUT THE USE of electronic gadgets, chemical substances it processes, and supplies the air-fuel mixture (energized air) to an efficacious mix, which is the exact combination that is needed to explode in the combustion chamber of internal combustion Engines.

This FUEL STABILIZER FOR INTERNAL COMBUSTION PETROL ENGINES avoids at its grass root level the excess supply of fuel to the combustion chamber of internal combustion Engines, when excess fuel is unburnt during explosion it creates poisonous gases at the exhaust. And during high speed the fuel stabilizer will screen excess fuel carried by air, when the mixture passes through the tubing to the air inlet of internal combustion Engines.

This FUEL STABILIZER FOR INTERNAL COMBUSTION PETROL ENGINES avoids emission of poisonous gases by the Engines, which now have direct ENVIRONMENTAL implications. The need to reduce vehicular pollution is the main priority of the governmental bodies all over the world. The Fuel Stabilizer for I/C Petrol Engines reduces tail pipe emissions, which is better than with the use of catalytic converters; it can meet the tightest emission norms in the world. And is far better compared with Euro IV Standards. The existing system of an internal combustion Engine or an automobile requires NO modification in installing the Fuel Stabilizer for I/C petrol Engines.

The FUEL STABILIZER FOR INTERNAL COMBUSTION PETROL ENGINES is a gadget which condenses and processes the petrol-air mixture (energized air) to a exact required combination, in a unit before passing it through a tube, to the air inlet of internal combustion Engine, by rejecting the direct supply of petrol to the carburetor or fuel injection systems. This invention does not vaporize the petrol in the inlet, of the internal combustion Engine, as done by the carburetor and multi point fuel injection systems. By this invention the question of vaporizing rich fuel in the combustion chamber, which emits poisonous gases on excess fed unburnt fuel is omitted once and for all. In addition to it its saves 75% of petrol compared to conventional methods like carburetor and M.P.F.I. injection systems.

This invention of FUEL STABILIZER FOR INTERNAL COMBUSTION PETROL ENGINES is:
A) A unit made of Metal, Steel Brass, Aluminum, Copper and Plastics to the shape, which can be accommodated within the bonnet, and to suit the various sizes of Engines capacities, in which it is mounted.
B) A Cylindrical doom made of Metals & Plastic to required size, to mix petrol & air, and store the energized air before it is fed to the out let of the unit, through a nozzle provided in the top of the unit, to transport the energized air to the tube.
C) A Cylindrical inverted doom attached with capsules rotates the air up and down in the petrol to enrich the air to feed ‘B’ of the unit.
D) An offset bowl round or square made of Metal or Plastic covered with a half chamber filled with synthetic and natural elements, which collects atmospheric air and feeds it to ‘C’ after it is filtered.
E) Made of available tubes of metal or plastic to the required diameter and length to connect the energized air to internal combustion Engine from outlet of ‘B’ of this unit to air inlet of the Engine.
F) An assembly of needle jet attached mechanical sensor to inlet fuel as required which is connected fuel line from fuel pump to petrol inlet nozzle

One of the preferred embodiment that the fuel stabilizer can be of any shape to be fit into any automobile internal combustion Engine system but preferably in a rectangular shape. It condenses and processes air-fuel mix to a required combination efficaciously in a unit or a gadget away from the engine and feeding the same energized air by a tube to the air inlet of internal combustion engines by disconnecting the fuel supply to the carburetor or multi point fuel injection system which is attached to the engine. A perforated sheet is provided at the bottom through which the hot air surrounding the Engine is permeated. This air is allowed to pass through a filter before mixing with the fuel. There is provided a fuel inlet nozzle (1) through which the fuel enters from a fuel tank and enters a semi vacuumed chamber (20) for partial Moisturizing of the fuel but mostly the fuel is in liquid state only. There is provided a fin just above the semi vacuumed chamber horizontally across that has inclination at both the bottom ends having perforations for the entry of the air, This portion of air is also allowed to mix with the air coming through the bottom perforated plate before passing through the air filter. The fuel comes out from the bottom end of the semi-vacuumed chamber and mixes with the filtered air. The air rotates up and down and the fuel-air ratio may vary similar to that of a bubble. The bigger the bubble the fuel content is less in the vicinity. Then the fuel-air mixture passes through a conical structure wherein the fuel-air ratio is maintained at a ratio ranging from 1:8 to 1:18, preferably from 1:12 to 1:18 and most preferably 1:13 to 1:16 and still more preferably 1:14 to 1:15. To achieve this ratio an angle from 50 degrees to 70 degrees, preferably 53 to 65 degrees and most preferably 53 to 63 degrees is maintained in the cone. There is provided a flow regulator at the constrictive end of the cone and near to the fuel enriched air outlet nozzle (1). The said regulator comprising a valve that allows the flow of the fuel-air mixes according to the acceleration of the Engine. There is also provided a fuel drain out valve (3), which is helpful during maintenance.

The fuel stabilizer of the present invention is fitted into the existing internal combustion Engine system in between the fuel tank and the carburetor and the flow of fuel from the fuel tank is limited in the stabilizer which means a precise ratio of fuel and air in the form of energized air is transported to the carburetor or MPFI and to the engine for combustion.

The fuel stabilizer of the present invention does not demand any particular shape and a definite dimension in the construction. Even the conical structure does not require any definite dimension but restricted to the conical shape maintaining the degree of inclination as specified above.

Variations known to the persons skilled in the art do possible and all the permutations and combinations are not covered in the present description. The present invention is mere explanatory in its description and it should be construed that all possible variations are within the scope of the present invention.

1. A Fuel stabilizer for Internal Combustion Petrol Engine is provided by:
a) a means for collecting the fuel from the fuel tank having an inlet,
b) a means for collecting the air from surroundings, having an inlet,
c) allowing the fuel and air to mix and pass through a plurality of chambers to prepare the judicious mix of fuel air mixture.

2. A fuel stabilizer for Internal Combustion Petrol Engine according to claim 1, wherein the fuel from the fuel tank is drawn and stored in semi vacuum chamber for further processing.

3. A fuel stabilizer for Internal Combustion Petrol Engine as claimed in claim 1 wherein the air, perforated bottom end of the said stabilizer and also through the perforations provided at the bottom end of the fin.

4. A fuel stabilizer for Internal Combustion Petrol Engine as claimed in claim 1 wherein the fuel and air are preferably filtered before mixing.

5. A fuel stabilizer for Internal Combustion Petrol Engine as claimed in claim 1 wherein the air and fuel are mixed in the desired ratio in the conical structure as shown in FIG. 3.

6. A fuel stabilizer for Internal Combustion Petrol Engine as claimed in claim 1 wherein the conical structure has an angle of inclination from 50 to 70 degrees, preferably from 53 to 65 and most preferably from 53 to 63 degrees.

7. A fuel stabilizer for Internal Combustion Petrol Engine as claimed in claim 5 wherein the fuel and air is mixed in a ratio ranging from 1:8 to 1:18, preferably from 1:12 to 1:18 and most preferably 1:13 to 1:16 and still more preferably 1:14 to 1:15.

8. A fuel stabilizer for Internal Combustion Petrol Engine according to claim 1 wherein the said stabilizer is fitted into the existing Internal Combustion Engine system at an appropriate location in between the fuel tank and the carburetor or MPFI injection system.

9. An automobile or any Internal Combustion Engine used for various purposes comprising the fuel stabilizer as claimed in claim 1.

10. (canceled)

11. (canceled)

12. A method of fuel stabilization for an internal combustion petrol engine, the method comprising:
collecting fuel from a fuel tank;
collecting air from surroundings; and
allowing the collected fuel and collected air to mix and pass through a plurality of chambers to prepare the judicious mix of fuel air mixture.
